(19) United States
(12) Patent Application Publication
(10) Pub. No.: US 2020/0149997 A1
(43) Pub. Date: May 14, 2020

(54) METHOD FOR MEASURING A LEVEL OF WEAR OF A TIRE OF A VEHICLE

(71) Applicant: Airbus SAS, Blagnac (FR)

(72) Inventor: Mustafa DEMIREL, TOULOUSE (FR)

(21) Appl. No.: 16/664,987

(22) Filed: Oct. 28, 2019

(30) Foreign Application Priority Data
Nov. 12, 2018 (FR) 1860417

(51) Int. Cl. G01M 17/02; G01B 11/24; G06T 7/00; G06T 7/70; G06T 7/55

(52) U.S. Cl. CPC G01M 17/027; G01B 11/24; G06T 7/97; G06T 2207/30108; G06T 7/55; G06T 7/0004; G06T 2207/10028; G06T 7/70

(57) ABSTRACT

A method for measuring a level of wear of a tire of a vehicle, the tire comprising a tread in which are hollowed out furrows. The method comprises: positioning a system, called tire inspection system, at a predefined position with respect to the tire; acquiring at least two images of the tread by using at least one image acquisition system included in the system, each image representing a different point of view on the tread; calculating a three-dimensional representation of the tread from each image acquired; determining at least one profile of the tread representative of depth variations on the tread; calculating a value representative of a depth of the furrows of the tread; determining information representative of a level of wear of the tire as a function of the value.

### CROSS-REFERENCES TO RELATED APPLICATIONS

This application claims the benefit of the French patent application No. 1860417 filed on Nov. 12, 2018, the entire disclosures of which are incorporated herein by way of reference.

### FIELD OF THE INVENTION

The present invention relates to a method that makes it possible to automatically measure a level of wear of a tire and a system implementing the method.

### BACKGROUND OF THE INVENTION

The vehicles for transporting goods or passengers, such as aircraft, boats, trucks, are costly vehicles. One known means of making these vehicles cost effective consists in maximizing their usage time. Thus, some commercial aircraft operators try to minimize the down times of their aircraft.

One known cause of aircraft down time is a change of one or more worn tires of the landing gear. Generally, the landing gear tires are the subject of an inspection by an operator just before a take-off The inspection of the operator consists notably in checking furrows hollowed out in a tread of each tire, these furrows being intended to dispel water when taxiing on wet ground, are of sufficient depth to serve their purpose. When at least one tire has to be changed, these inspections just before the take-off can lead to operational delays, even flight cancellations. In order to avoid these delays, it is recommended practice to inspect each tire of each aircraft of a fleet of aircraft during non-operating phases of the aircraft, for example during night time phases. However, such inspections are lengthy and costly, all the more so when the fleet of aircraft is significant. Moreover, since these inspections are conducted by one or more operators, they can be subject to differences in assessments of the level of wear of a tire depending on the operators.

The article “Airplane tire inspection by image processing techniques, 5th Mediterranean Conference on Embedded Computing MECO'2016, Bar, Montenegro, Igor Jovančević, Al Arafat, Jean-José Orteu, Thierry Sentenac” proposes a method that makes it possible to automatically measure a level of wear of an aircraft tire. This method is based on an acquisition of an image of a tire and on an analysis of this image. This method comprises a gradient analysis at the level of furrows of the tires that makes it possible to estimate a depth of the furrows. One limitation of this method is that the gradients at the level of the furrows of a tire are influenced by conditions of illumination of the tire. The result thereof is that the method can be of different results for one and the same tire according to an orientation and/or an intensity of a light source lighting the tire.

It is desirable to overcome these drawbacks of the prior art. It is notably desirable to propose a method which makes it possible to assess a level of wear of a tire that does not feature the limitations of the prior art.

### SUMMARY OF THE INVENTION

According to a first aspect of the invention, the present invention relates to a method for measuring a level of wear of a tire of a vehicle, the tire comprising a tread in which are hollowed out furrows. The method comprises: positioning a system, called tire inspection system, at a predefined position with respect to the tire; acquiring at least two images of the tread by using at least one image acquisition system included in the tire inspection system, each image representing a different point of view on the tread; calculating a three-dimensional representation of the tread in the form of a depth map from each image acquired; determining at least one profile of the tread, the profile being representative of depth variations on the tread; calculating a value representative of a depth of the furrows of the tread; determining information representative of a level of wear of the tire as a function of the value.

The method therefore makes it possible to reliably and automatically determine a level of wear of a tire.

According to one embodiment, the vehicle is an aircraft.

According to one embodiment, the information representative of a level of wear is a number of take-offs and of landings remaining before having to change the tire.

Thus, it is possible to anticipate when to change a tire.

According to one embodiment, the method is executed fully by the tire inspection system, and comprises: obtaining a position of the vehicle; obtaining a position of the tire as a function of the position of the vehicle; automatically positioning the tire inspection system at the predefined position as a function of the position of the tire.

Thus, the tire inspection system is autonomous since it can inspect tires without the intervention of an operator.

According to a second aspect of the invention, the invention relates to a system for inspecting tires of a vehicle, each tire comprising a tread in which are hollowed out furrows. The system comprises: positioning means for positioning the tire inspection system at a predefined position with respect to the tire; image acquisition means for acquiring at least two images of the tread; processing means for calculating a three-dimensional representation of the tread in the form of a depth map from each image acquired; processing means for determining at least one profile of the tread, the profile being representative of depth variations on the tread; processing means for calculating a value representative of a depth of the furrows of the tread; processing means for determining information representative of a level of wear of the tire as a function of the value.

According to one embodiment, the system comprises means for displaying the information representative of a level of wear of the tire.

According to a third aspect of the invention, the invention relates to a computer program product, comprising instructions for implementing, by a device, the method according to the first aspect by a processor of the device.

According to a fourth aspect of the invention, the invention relates to storage means, storing a computer program comprising instructions for implementing, by a device, the method according to the first aspect when the program is run by a processor of the device.

### BRIEF DESCRIPTION OF THE DRAWINGS

The features of the present invention mentioned above, and others, will emerge more clearly on reading the following description of an exemplary embodiment, the description being given in relation to the attached drawings, in which:

FIG. 1 schematically illustrates an example of a vehicle for which the invention is applicable;

FIG. 2 illustrates a landing gear of an aircraft;

FIG. 3A schematically illustrates two tires in good condition of a landing gear;

FIG. 3B schematically illustrates a worn tire of a landing gear;

FIG. 3C schematically illustrates a detail of the worn tire;

FIG. 4A schematically illustrates a plan view of a tire inspection system according to the invention;

FIG. 4B schematically illustrates a side view of the tire inspection system according to the invention;

FIG. 5 illustrates an example of hardware architecture of a processing module included in the tire inspection system;

FIG. 6 illustrates an example of method for measuring a level of wear of a tire; and

FIG. 7 schematically represents a profile of a tread of a tire.

### DETAILED DESCRIPTION OF THE PREFERRED EMBODIMENTS

The detailed description hereinbelow sets out to describe an embodiment of the present invention in a context of an aircraft. The principles of the present invention do however apply in a wider context. The principles of the present invention are indeed applicable to other vehicles such as trucks, buses, motor vehicles or motorcycles.

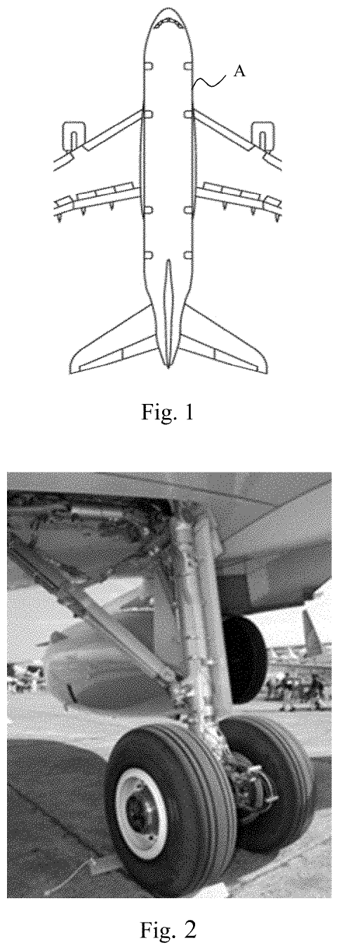

In relation to FIGS. 1 and 2, an aircraft A comprises a landing gear provided with tires.

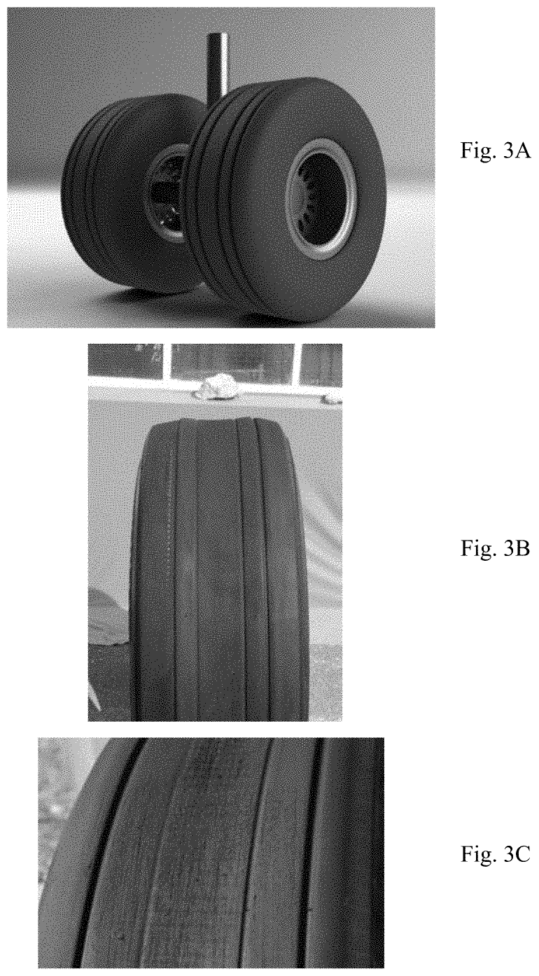

With reference to FIGS. 3A, 3B and 3C, as for all vehicles equipped with wheels provided with tires, a landing gear tire changes during its use. FIG. 3A thus represents a landing gear comprising two new tires. As FIG. 3A shows, a new tire comprises a tread comprising deep and well-marked furrows. FIG. 3B represents a worn landing gear tire. The furrows of this tire are very much diminished, even virtually erased as can be seen in FIG. 3C which represents a zoom on the tread of the tire of FIG. 3B.

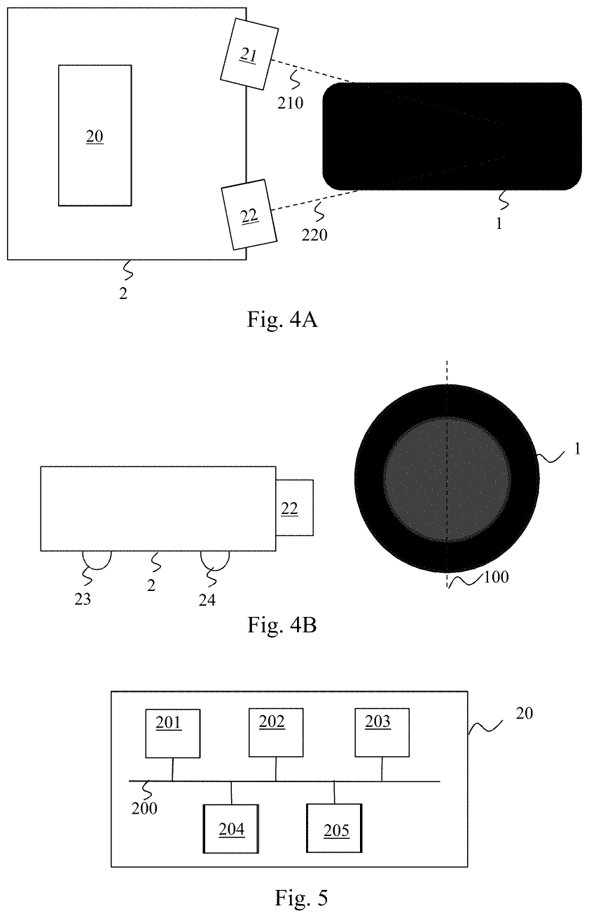

FIG. 4A schematically illustrates a plan view of a tire inspection system 2 according to the invention.

The tire inspection system 2 comprises a processing module 20 and at least one image acquisition module. In the example of FIG. 4A, the tire inspection system comprises two image acquisition modules 21 and 22 such as cameras. These two image acquisition modules 21 and 22 form a stereoscopic system that makes it possible to simultaneously acquire a pair of images of a tread of a tire 1 positioned in front of the tire inspection system 2. Each image of the pair of images is representative of a different point of view on the tread of the tire. In operation, the tire inspection system 2 is positioned at a predefined position with respect to the tire 1 such that each image acquisition module 21 and 22 can acquire an image of one and the same portion of tread of the tire 1. For example, the tire inspection system 2 is positioned facing the tread of the tire 1 in such a way that an optical axis 210 of the image acquisition module 21 crosses an optical axis 220 of the image acquisition module 22 on a vertical axis 100 passing through a center of a circle formed by the tire 1.

FIG. 4B schematically illustrates a side view of the tire inspection system according to the invention.

The tire inspection system 2 comprises a positioning module that makes it possible to position the system 2 at the predefined position with respect to the tire 1. This positioning module comprises, for example, pairs of wheels 23 and 24.

In one embodiment, these pairs of wheels 23 and 24 allow an operator to position the tire inspection system 2 at the predefined position with respect to the tire.

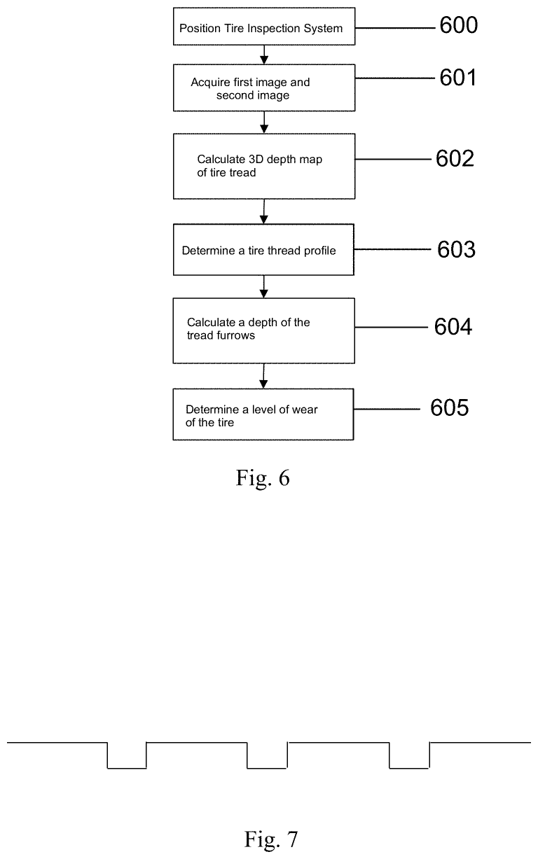

In one embodiment, the pairs of wheels 23 and 24 are actuated by at least one motor. In this case, as will be described hereinbelow in relation to FIG. 6, the tire inspection system 2 is positioned automatically with respect to the tire that it has to inspect.

In one embodiment, the tire inspection system 2 comprises a single image acquisition system. In this case, the position of the image acquisition system is modified, either manually by an operator, or automatically, with respect to the tire that has to be inspected in order to obtain at least two images of two different points of view of the tread of the tire.

In one embodiment, the tire inspection system 2 comprises a plurality of image acquisition systems comprising more than two image acquisition systems, each image acquisition system making it possible to acquire an image of a different point of view of the tread of the tire.

FIG. 5 illustrates an example of hardware architecture of the processing module 20 included in the tire inspection system 2.

According to the example of hardware architecture represented in FIG. 5, the processing module 20 then comprises, linked by a communication bus 200: a processor or CPU (“Central Processing Unit”) 201; a random access memory RAM 202; a read-only memory ROM 203; a storage unit such as an SD (“Secure Digital”) card or a storage medium reader, such as an SD card reader 204; and a communication interface 205 allowing the processing module 20 to control the image acquisition modules 21 and 22 and to receive images acquired by the modules. The communication interface thus allows the tire inspection system 2 to transmit, for example to a smartphone or to a computer of an operator, a message indicating a state of each tire inspected.

The processor 201 is capable of executing instructions loaded into the RAM 202 from the ROM 203, from an external memory (not represented), from a storage medium (such as an SD card), or from a communication network. When the tire inspection system is powered up, the processor 201 is capable of reading the instructions from the RAM 202 and of executing them. These instructions form a computer program causing the implementation, by the processor 201, of the method described in relation to FIG. 6.

All or part of the method described in relation to FIG. 6 can be implemented in software form by the execution of a set of instructions by a programmable machine, for example a DSP (“Digital Signal Processor”) or a microcontroller, or be implemented in hardware form by a machine or a dedicated component, for example an FPGA (“Field-Programmable Gate Array”) or an ASIC (“Application-Specific Integrated Circuit”).

In one embodiment, when the pairs of wheels 23 and 24 of the tire inspection system 2 are actuated by a motor, the processing module 20 controls the motors. The communication interface 205 makes it possible, for example, to receive commands from a control device such as a remote control handled by an operator. The tire inspection system can thus be positioned remotely.

In another embodiment, when the processing module 20 controls the motor or motors actuating the wheels 23 and 24, the communication interface makes it possible to obtain, for example from a central unit present in an airport or directly from each aircraft when the latter is stopped in an airport, information representative of a position of stoppage of the aircraft in the airport and information representative of the type of the aircraft. Based on the information representative of the position of stoppage of the aircraft and of the information representative of the type of the aircraft, the processing module is capable of determining the position of each tire of the aircraft. The processing module then determines the predefined position with respect to each tire. In this embodiment, the tire inspection system comprises a geolocation module such as a GPS (“Global Positioning System”) module allowing it to know its current position. Thus, for each tire that has to be inspected, knowing its current position and the predefined position with respect to the tire, the tire inspection system 2 is positioned automatically at the predefined position in order to determine the state of the tire.

FIG. 6 illustrates an example of method for measuring a level of wear of a tire. The method described in FIG. 6 is performed in succession for each tire of an aircraft.

In a step 600, the tire inspection system 2 is positioned at the predefined position with respect to a tire. As described above, the positioning of the tire inspection system can be performed by an operator, or be performed automatically by using the motors to actuate the pairs of wheels 23 and/or 24 under the control of the processing module.

Once positioned in the predefined position, in a step 601, the processing module 20 launches an acquisition of a first image by the image acquisition system 21 and of a second image by the image acquisition system 22, each image representing a different point of view on the tread.

In a step 602, the processing module 20 calculates a three-dimensional (3D) representation of the tread of the tire from each image acquired. In one embodiment, the 3D representation is a depth map (or a disparity map). A disparity map is a digital image containing information representative of correlations between points deriving from two views of one and the same scene taken from different points of view. From a distance between two corresponding points (that is to say, two points of two different images deriving from one and the same point in the scene), the distance (i.e., the depth) between the camera and the point in the scene is directly deduced. In the step 602, the method described in the article “Improved Depth Map Estimation from Stereo Images Based on Hybrid Method, Patrik KAMENCAY, Martin BREZNAN, Roman JARINA, Peter LUKAC, Martina ZACHARIASOVA, RADIOENGINEERING, VOL. 21, NO. 1, APRIL 2012” is, for example, applied. Upon the acquisition of the images by the image acquisition modules 21 and 22, the tire is vertical. A line of the depth map therefore corresponds to a line of each image acquired by the image acquisition modules. Each furrow hollowed out in the tread of the tire appears vertical. Each line of the depth map represents depth variations in the tread of the tire on a horizontal axis and therefore corresponds to a profile of the tread. FIG. 7 schematically represents a profile of a tread of a tire.

In a step 603, the processing module determines at least one profile of the tread of the tire from the depth map.

In a step 604, the processing module 20 calculates a value representative of a depth of the furrows of the tread from at least one determined profile.

In one embodiment, the processing module 20 uses a profile and calculates a deviation between the highest depth and the lowest depth on this profile. The profile used, for example, divides the depth map into two equal parts. The value representative of the depth of the furrows of the tread is then the calculated deviation.

In one embodiment, the processing module 20 uses a plurality of profiles, calculates, for each profile, the deviation between the highest depth and the lowest depth and calculates an average of the deviations thus obtained. The plurality of profiles comprises, for example, “ten” profiles chosen at random positions in the depth map. The value representative of the depth of the furrows of the tread is then the average of the calculated deviations.

In a step 605, the processing module 20 determines information representative of a level of wear of the tire as a function of the value. In one embodiment, the information representative of a level of wear is binary, that is to say, it indicates whether or not the tire is usable. In this embodiment, to obtain this binary information, the processing module 20 compares the information representative of the depth of the furrows to a predetermined depth threshold. When the information representative of the depth of the furrows is greater than the predetermined depth threshold, the tire is declared usable. Otherwise, the tire is declared to be changed. The binary information representative of a level of wear of the tire is then supplied to an operator.

In one embodiment, in addition to the binary information, the processing module calculates a number of landings and of take-offs remaining before having to change the tire by using the value representative of the depth of the furrows of the tread. To do this, the processing module 20 uses information representative of a reduction of the depth of the furrows generated for each landing and take-off pairing. The information representative of a reduction of the depth of the furrows is, for example, known to the processing module 20 and supplied by a constructor of the tire and for the type of airplane using the tire. In this embodiment, the processing module 20 calculates a difference between the information representative of the depth of the furrows and the predetermined depth threshold and divides the difference obtained by the information representative of a reduction of the depth of the furrows to obtain the number of landings and of take-offs remaining before having to change the tire. The number of landings and of take-offs remaining before having to change the tire is then supplied to an operator.

In one embodiment, the tire inspection system 2 comprises a display module, such as a screen. Each information representative of the level of wear of a tire is displayed on the display module in order for an operator to be able to consult it.

In one embodiment, each information representative of a level of wear of a tire is transmitted by the tire inspection system 2 to a terminal of an operator such as a computer, a tablet or a smartphone in order for the latter to display the information.

In one embodiment, each tire of an aircraft is referenced in a database of an operator of the aircraft. On each use of the tire inspection system 2, the tire inspection system communicates a result of its inspection to a server managing the database. The server records each value representative of the depth of the furrows for each tire. From this information, the server can calculate a trend of the wear of each tire and thus calculate, for each tire, a more accurate value of the information representative of a reduction of the depth of the furrows on each take-off/landing. Upon a new inspection of a given tire, the tire inspection system 2 can then communicate with the server in order for the tire inspection system 2 to communicate to the server the information representative of a reduction of the depth of the furrows corresponding to this tire. Thus, a tire which is worn more rapidly than another tire can easily be identified.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for measuring a level of wear of a tire of an aircraft, said tire comprising a tread in which are hollowed out furrows, comprising:
positioning a tire inspection system at a predefined position with respect to said tire;
acquiring at least two images of the tread by using at least one image acquisition system included in the tire inspection system, each image representing a different point of view on said tread;
calculating a three-dimensional representation of said tread as a depth map from each image acquired;
determining at least one profile of said tread, said profile being representative of depth variations on said tread;
calculating a value representative of a depth of the furrows of said tread;
determining information representative of the level of wear of said tire as a function of said depth value, the information representative of the level of wear being a number of landings and of take-offs remaining before having to change said tire.

2. The method according to claim 1, wherein the method is executed fully by the tire inspection system, and comprises:
obtaining a position of the aircraft;
obtaining a position of said tire as a function of the position of said vehicle;
automatically positioning the tire inspection system at the predefined position with respect to the position of said tire.

3. A system for inspecting tires of an aircraft, each tire comprising a tread in which are hollowed out furrows, comprising:
positioning means configured to position the tire inspection system at a predefined position with respect to said tire;
image acquisition means configured to acquire at least two images of the tread;
processing means configured to calculate a three-dimensional representation of said tread as a depth map from each image acquired;
processing means configured to determine at least one profile of said tread, said profile being representative of depth variations on said tread;
processing means configured to calculate a value representative of a depth of the furrows of said tread;
processing means configured to determine information representative of a level of wear of said tire as a function of said value, the information representative of a level of wear being a number of landings and of take-offs remaining before having to change said tire.

4. The system according to claim 3, further comprising means configured to display the information representative of the level of wear of said tire.

5. A computer program product comprising instructions for implementing, by a device, the method according to claim 1 by a processor of the device.

6. A storage means, configured to store a computer program comprising instructions for implementing, by a device, the method according to claim 1 when said program is run by a processor of said device.
